(19) United States
(12) Patent Application Publication
(10) Pub. No.: US 2017/0237602 A1
(43) Pub. Date: Aug. 17, 2017

(54) COMPUTER SYSTEM MONITORING BASED ON ENTITY RELATIONSHIPS

(71) Applicant: Microsoft Technology Licensing, LLC, Redmond, WA (US)

(72) Inventors: Andrea DAmato, Kirkland, WA (US); Alexander Say Go, Sammamish, WA (US); Donald MacGregor, Mercer Island, WA (US); Galen Dean Barbee, Issaquah, WA (US); Noah Aaron Cedar Davidson, Woodinville, WA (US); Gregorio Maeso, Kirkland, WA (US)

(21) Appl. No.: 15/045,114

(22) Filed: Feb. 16, 2016

(51) Int. Cl. H04L 12/24; H04L 29/08

(52) U.S. Cl. CPC H04L 41/065; H04L 67/10; H04L 41/0654

(57) ABSTRACT

Monitoring the health of a computer system based on the relationships of entities, and the intelligent presentation of alerts based thereon. A rule-based engine may perform the monitoring and alerting. Problem(s) and problem entity(s) within a computing system are identified during the monitoring. Relationship(s) of the problem entity(s) with other entities in the computer system are then identified. A relationship type for each of the identified relationship(s) is determined. A combination of the identified problem(s), the identified problem entity(s), and the determined relationship type(s) are analyzed to determine root cause(s) of the problem(s). Based on the root cause(s), an alert is presented to a user comprising one or more actions the user can take regarding one or more user-visible entities of the computer system to fix the identified problem(s). The alerts may be fewer in number and more intuitive due to the analysis.

### BACKGROUND

Computer systems and related technology affect many aspects of society. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks. Accordingly, the performance of many computing tasks is now being distributed across a number of different computer systems and/or a number of different computing environments.

Cloud computing, in particular, has continued to see large gains in popularity. Cloud computing providers offer users the ability to deploy large and complex computer systems sufficient to meet virtually any computing need. While the large scale of these deployed cloud computing systems provides great flexibility and computing power to users, it also presents great complexity in terms of maintaining the deployed systems in good working condition.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to monitoring the health of a computer system based on the relationships of entities included in the computer system. Furthermore, based on such monitoring and further automated analysis, alerts may be judiciously presented to the user in a manner that the user is not overwhelmed by too many alerts. Likewise, the alerts are more informative. For instance, by factoring in the types of relationships that entities within a computer system have, incidental problems within the computer system (that may obscure actual root causes of any problems within the computer system) may be identified and filtered out without being exposed to the user.

For example, in some embodiments, a rules-based engine may perform the monitoring of system health and presentation of alerts. One or more problems within a computer system are identified, as well as one or more entities within the computer system that are causing the one or more problems. One or more relationships that the one or more problem entities have with other entities in the computer system are then identified. Furthermore, a relationship type for each of at least one of the identified relationships is determined.

A combination of the one or more identified problems, the one or more identified problem entities, and the determined relationship type are then analyzed in order to determine one or more root causes of the one or more problems. Finally, based on the one or more root causes, an alert is presented to a user that comprises one or more actions the user can take with respect to one or more user-visible entities of the computer system in order to fix the one or more identified problems.

The relationships of the entities provide a clue as to the root cause(s) of a problem, and thus which problems may be brought to the users attention, and which alerts would simply confuse. For instance, the user may not even be aware of the existence of some entities of the computing system, and such alerts regarding such entities would thus not be helpful. Instead, the user is provided with a fewer number of more relevant and interpretable alerts that the user is more likely to be able to take action on to remedy the root cause(s) of the problem.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 symbolically illustrates a computer system in which some embodiments described herein may be employed.

FIG. 2 symbolically illustrates an example computer system architecture for monitoring the computer system.

FIG. 3 symbolically illustrates a containment relationship of entities in a computer system.

FIG. 4 symbolically illustrates a composition relationship of entities in a computer system.

FIG. 5 symbolically illustrates an aggregation relationship of entities in a computer system.

FIG. 6 illustrates a flow chart of an example method for monitoring the health of a computer system.

### DETAILED DESCRIPTION

At least some embodiments described herein relate to monitoring the health of a computer system based on the relationships of entities included in the computer system. Furthermore, based on such monitoring and further automated analysis, alerts may be judiciously presented to the user in a manner that the user is not overwhelmed by too many alerts. Likewise, the alerts are more informative. For instance, by factoring in the types of relationships that entities within a computer system have, incidental problems within the computer system (that may obscure actual root causes of any problems within the computer system) may be identified and filtered out without being exposed to the user.

For example, in some embodiments, a rules-based engine may perform the monitoring of system health and presentation of alerts. One or more problems within a computer system are identified, as well as one or more entities within the computer system that are causing the one or more problems. One or more relationships that the one or more problem entities have with other entities in the computer system are then identified. Furthermore, a relationship type for each of at least one of the identified relationships is determined.

A combination of the one or more identified problems, the one or more identified problem entities, and the determined relationship type are then analyzed in order to determine one or more root causes of the one or more problems. Finally, based on the one or more root causes, an alert is presented to a user that comprises one or more actions the user can take with respect to one or more user-visible entities of the computer system in order to fix the one or more identified problems.

The relationships of the entities provide a clue as to the root cause(s) of a problem, and thus which problems may be brought to the users attention, and which alerts would simply confuse. For instance, the user may not even be aware of the existence of some entities of the computing system, and such alerts regarding such entities would thus not be helpful. Instead, the user is provided with a fewer number of more relevant and interpretable alerts that the user is more likely to be able to take action on to remedy the root cause(s) of the problem.

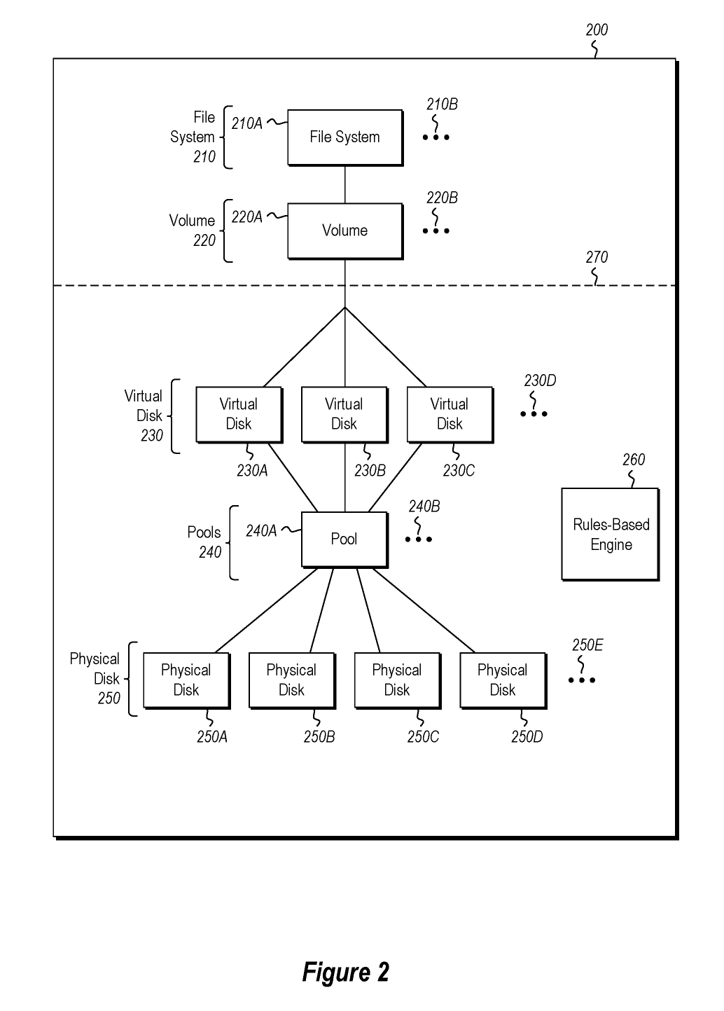

Because the principles described herein operate in the context of a computing system, a computing system will first be described as an enabling technology for the principles described herein. Thereafter, further details regarding the monitoring of the health of computer systems will be described with respect to FIGS. 2 through 6.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses, watches, bands, and so forth). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

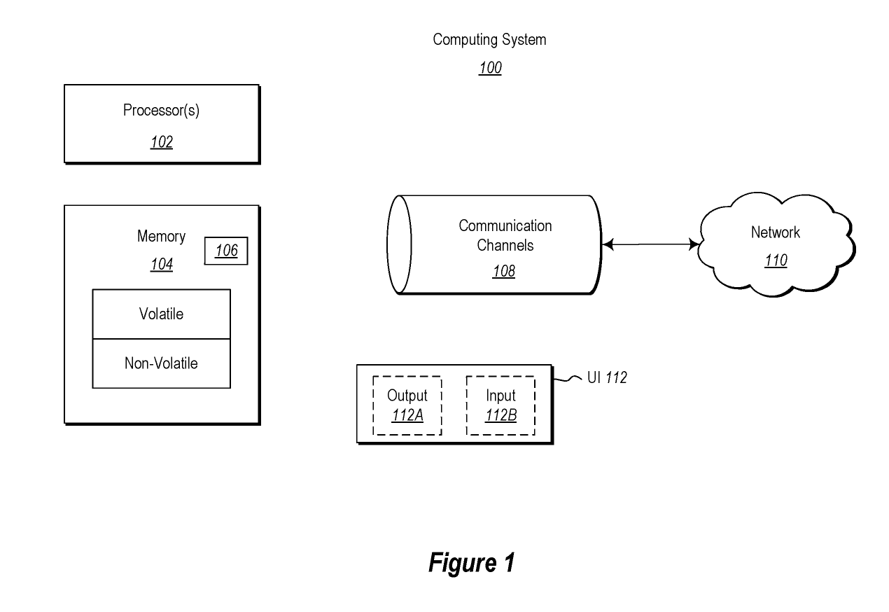

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

Each of the depicted computer systems is connected to one another over (or is part of) a network, such as, for example, a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

The computing system 100 has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “controller”, “validator”, “runner”, “deployer” or the like, may also be used. As used in this description and in the case, these terms (regardless of whether the term is modified with one or more modifiers) are also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth. In accordance with the principles describe herein, alerts (whether visual, audible and/or tactile) may be presented via the output mechanism 112A.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that readable media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses or watches) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates an example architecture of a computer system 200 for monitoring its own health. While many more types of entities could be included, the entities shown are for example purposes only. Accordingly, FIG. 2 illustrates an example computer architecture with various computer system entities, from high-level entities to low-level entities. The principles described herein are not limited to any particular type of entity. However, in the specific example of FIG. 2, the entities are physical disks, pools or disks, virtual disks, volumes, and file systems, which are interrelated in particular ways. That said, the principles described herein are equally applicable to any computing system having any number of entities of any variety of types that are interrelated in any of a variety of ways. However, a specific example will be helpful to extrapolate an understanding of the broader principles encompassed herein. As for the entities themselves, the entities may be executable components or any device or system that an executable component is capable of communicating with, affecting, or being affected by.

As a specific example only, physical disks 250 are shown as components of a pool 240A, with virtual disks 230 being created from the pool. Virtual disks 230 are used to create volume 220 with associated file system 210. In this specific example, there are four physical disks 250A through 250D; but as represented by ellipses 250E, the principles described herein are not limited to the number of physical disks 250, nor to there being any entities that are physical disks. Also, in this specific example, there is one disk pool 240A; but as represented by ellipses 240B, the principles described herein are not limited to the number of pools 240 (nor to there being any entities that are pools). Furthermore, there are three virtual disks 230A through 230C shown; but the ellipses 230D represent that there may be any number, zero or more, of the virtual disks. Next, there is a single volume 220A shown, but the ellipses 220B represent that there may be any number, zero or more, of volumes. Finally, there is a single file system 210A shown, but the ellipses 210B represent that there may be any number, zero or more, of file systems.

The dotted-line 270 represents a barrier between user-visible entities (above the dotted-line 270) and non-user-visible entities (below the dotted-line 270). For instance, in the specific example of FIG. 2, file system 210 and volume 220 are visible to the user, all other entities are not. User-visible entities are those entities that the computer system considers that the user is accustomed to control and/or at least see a visualization of. For example, an ordinary user may only be able to control and/or see visualizations of file system 210 and volume 220.

Notably, computer system 200 also includes rules-based engine 260, which may continually monitor the overall health of the computer system 200. The rules-based engine may further have some level of intelligence and a complete knowledge of the system design. When the system design is updated, the rules-based engine may either automatically become aware of the changes or may be made aware manually. The rules-based engine 260 may be an example of the executable component 106 of FIG. 1.

Furthermore, the rules-based engine may use artificial intelligence to learn from previous failures that have occurred in the system to repair similar failures when they occur. Accordingly, the rules-based engine may use this intelligence and knowledge of the system to understand relationships of entities within the system and how symptoms in one entity may affect another entity. Thus, the rules-based engine may utilize its knowledge of the relationships of each entity within the system in order identify system problems that are only incidental to actual root causes, and thus refrain from alerting a user regarding such incidental problems.

More specifically, the rules-based engine 260 may be configured to identify any failures or problems occurring within the system 200, including a loss of redundancy, a disk failure, a decrease in quality of service, overheating, a decrease in performance, a decrease in capacity, a decrease in available storage, a decrease in processing capabilities, a decrease in memory, a decrease in bandwidth, and so forth. As briefly mentioned, the rules-based engine may further be configured to identify which entities within the system are causing the problems. For instance, if a loss of redundancy has occurred, the rules-based engine may identify that a failure in physical disk 250B has caused the loss of redundancy.

Accordingly, the rules-based engine is not only capable of identifying which entities are causing problems and the relationships of those problem entities to other entities, but can also determine relationship types for each relationship of a problem entity. In one example, there are three basic types of relationships that the rules-based engine may determine; namely, containment relationship types, composition relationship types, and aggregation relationship types, as described herein.

It should also be noted that rules by which the rules-based engine operates may be added or updated. Such rules may be added/updated by any appropriate means, including by download from an appropriate source or even manually by a user. Accordingly, a user may add/update one or more rules of the rules-based engine that correspond to the user's specific needs and circumstances. For example, a user may add a rule that includes lowering the urgency of a particular action to take in alert when the number of disks in a pool that are currently online is greater than 90%.

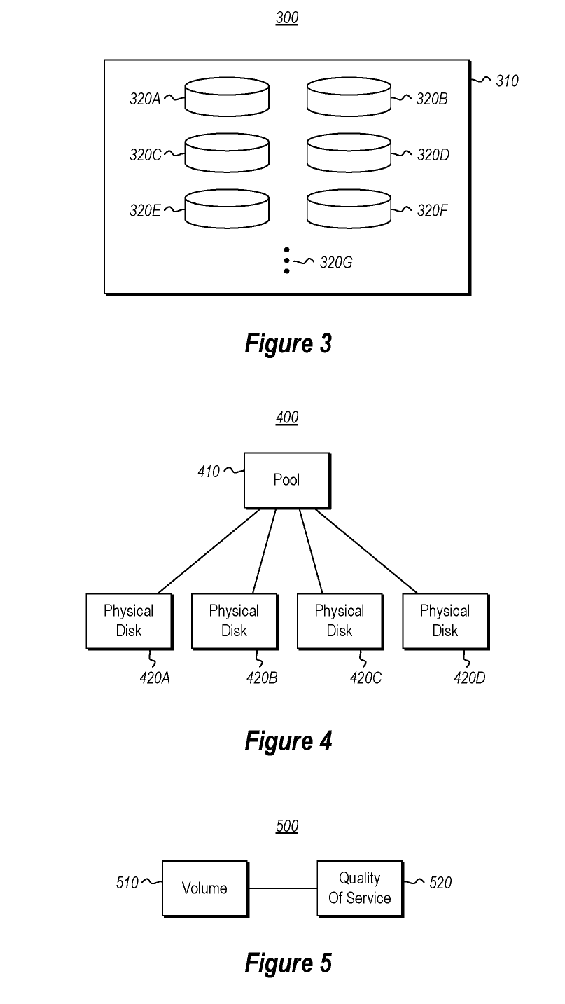

Containment relationship types generally comprise those relationships in which one entity is contained, or enclosed, within another entity and the enclosed entity is not a component of the container entity. As illustrated in FIG. 3, an example of this may be disks 320A through 320G (referred to collectively herein as “disks 320”) contained within storage enclosure 310. Disks 320, while enclosed within storage enclosure 310, are not a component of the storage enclosure. Containment relationship types may also be present when there is only a single path to a given entity. For example, there may be a container relationship between a storage enclosure and a server, wherein the storage enclosure is not shared with any other server (i.e., only that server has access to the storage enclosure). Such a relationship would entail the server being the container and the storage enclosure being the containee.

When two entities having a containment relationship type have been identified, generally the container in the relationship will be the root cause of any problems. Again, using the example illustrated in FIG. 3, if rules-based engine 260 identifies both a failure of one or more of the disks 320 and a failure of the storage enclosure 310, generally the failure of the storage enclosure is causing the failure of the one or more disks (i.e. the failure of the storage enclosure is the root cause of both the storage enclosure failures and the one or more disk failures). Thus, once the problem(s) with the storage enclosure are corrected, the problems with the disks will generally be corrected, as well.

Composition relationship types generally comprise those relationships in which one entity is a component of a parent entity. As illustrated in FIG. 4, an example of this may be pool 410 with component physical disks 420A through 420D (referred to collectively herein as “physical disks 420”). Another example of a composition relationship type may be component entities such as a fan, a sensor, or a power supply of a parent entity such as a server or a storage enclosure. When two entities having a composition relationship type have been identified, generally the component entity in the relationship will be the root cause of any identified problems, as opposed to the parent entity being the root cause.

Again, using the example illustrated in FIG. 4, if rules-based engine 260 identifies both a failure of one or more of the physical disks 420 and a failure of the pool 410, generally the failure of the one or more physical disks is causing the failure of the pool (i.e., the failure of one or more physical disks is root cause of both the failures of the one or more disks and the failure of the pool). Thus, once the failure(s) with the physical disks are corrected, the failure of the pool will be corrected, as well.

The rules-based engine may also use its intelligence and knowledge of the system design to identify relationship types between components that may not be initially obvious. For example, the rules based engine may identify a composition relationship type in a computer system that includes virtualized physical connections. Virtualized physical connections can exist where instead of connecting every server to every storage enclosure within the computer system, only one server is connected to the storage enclosures. The rest of the servers in the system then use a network connection to that one server in order to communicate with the storage enclosures. These servers therefore have a virtual connection to the storage enclosures within the system, which virtual connection is seen as being a physical connection by higher software layers in the system.

In such cases, a simple network error will cause the higher software layers to believe that there is a problem with a physical connection, which in reality does not exist. Accordingly, by treating the storage enclosure as having a component relationship with the network connection (i.e., the network connection is a component of the storage enclosure), complaints of a physical connection failure by the higher software layers may generally be filtered out, leaving only the failure of the network connection as the root cause. Thus, virtualized computer entities and particular software may also be seen as entities with entity relationships within a computer system.

Aggregation relationship types generally comprise those relationships in which one entity is only loosely related to another entity. As symbolically illustrated in FIG. 5, an example of this may be volume 510 and its relationship with quality of service (QOS) 520. When two entities having an aggregation relationship type have been identified, generally neither entity is a root cause of a failure in the other. Again, using the example illustrated in FIG. 5, if rules-based engine 260 identifies both a failure of the volume 510 and a problem with QOS 520, generally neither failure is a root cause of the other, regardless of their loosely-based relationship.

Utilizing these three relationship types, the rules-based engine may filter out incidental failures/problems that are not root causes. The filtering itself may be done in any number of ways. For instance, the rules-based engine may assign a filtering value to each identified problem entity based on the types of relationships the particular problem entity has. In such embodiments, the filtering value may represent the certainty that a problem entity and its associated failures/problems can be ignored based on the certainty that the problem entity is a root cause of one or more failures/problems.

For example, if a problem entity is a component of a problem parent entity, the component problem entity may be assigned a filtering value representing a very high certainty that the component problem entity is a root cause of associated failures/problems. Thus, the component problem entity would be very unlikely to be filtered out or ignored when determining the root cause(s). Likewise, the problem parent entity may be assigned a filtering value representing a very low certainty that the parent problem entity is the root cause of associated failures/problems. Thus, the parent problem entity would be very likely to be filtered out or ignored when determining the root cause(s). Similarly, this same logic could be applied to both the containment relationship type and the aggregation relationship type based on the principles described herein.

Another example of filtering may include a percentage of certainty regarding whether or not the problem is a root cause. For example, a problem may be given a 100% when there is an absolute certainty that the problem is a root cause (or 0% when there is an absolute certainty that it is not a root cause). In some embodiments, there may be a default level of certainty assigned when it is unclear whether or not the problem is a root cause. Accordingly, the rules-based engine may assign any percentage based on the likelihood of the problem being a root cause. In such embodiments, the rules-based engine may also use artificial intelligence to continue to refine the percentages that it assigns to each problem or problem entity based on previous experience, including the accuracy of previous percentages assigned based on similar problems and/or problem entities and so forth.

Furthermore, in either of the two embodiments just described (or any other embodiment) there may be a threshold that determines when a problem will be filtered out. For example, any problem with less than a 30% certainty of being a root cause will be filtered out. In other embodiments, the threshold may require absolute certainty in order to filter out any problems (i.e., 100% certainty of not being a root cause or 0% certainty of being a root cause). Similarly, when there are two or more problems, the certainty level may also determine the order in which the problems are prioritized to be resolved (e.g., a problem with 50% certainty that it is a root cause will be emphasized over a problem with a 30% certainty that it is a root cause).

There may also be a predetermined order of which relationship types take precedence over other relationship types in terms of filtering and prioritization of what problems to correct first. This may be based on which relationship type is most likely to be a root cause even though they have the same assigned certainty. For example, there may be situations where two (or more) problems have the exact same certainty of being a root cause, but one is a component in a composition type relationship and the other is a container in a containment type relationship. In such cases there may be an order of precedence such as a component entity taking precedence over a container entity, wherein the component entity is more likely to be a root cause and less likely to get filtered out. Thus, the component entity will be prioritized to be corrected before the container entity.

In some embodiments, component entities may take precedence over parent entities, which take precedence over container entities, which take precedence over containee entities, which take precedence over aggregation entities. In other embodiments, component entities may take precedence over container entities, which take precedence over parent entities, which take precedence over containee entities which take precedence over aggregation entities. While these are only a few examples, these orders of precedence may be in any order of the types of entities described herein that fits a particular computer system.

It should also be noted that when two or more entities have an entity relationship, those entities together may form one logical entity. For example, a component entity that has a composition relationship with a parent entity may combine together to form one logical entity. In a more specific example, a fan on a server may have a composition relationship with that server, wherein the fan is the component and the server is the parent. That same server may then have a containment relationship with a storage enclosure, wherein the server is the container and the storage enclosure is the containee. In such a situation, the fan may malfunction, causing problems with both the server and the storage enclosure. However, the fan and server together may be seen as the container in the containment relationship with the storage enclosure (i.e., the containee). Accordingly, because the container is generally the root cause of a problem in a containment relationship, the fan/server container entity would be seen as the root cause of any problems in the fan, server, and storage enclosure, despite the fan not having a direct relationship with the storage enclosure.

Once a determination has been made regarding the relationship types of identified problem entity relationships, the rules-based engine may make a final determination of which problems are actual root causes. This may occur in a number of ways. For example, the rules-based engine may analyze a combination of the identified problems, the identified problem entities, and the determined relationship types in order to determine one or more root causes of any identified problems.

In other embodiments, the rules-based engine may use only the determined relationship types in order to determine one or more root causes of any identified failures/problems within the computer system. In yet other embodiments, the rules-based engine may use only an assigned certainty regarding the likelihood of an identified problem being a root cause in order to determine one or more root causes of the identified failures/problems within the computer system. In yet other embodiments, the rules-based engine may analyze a combination of the identified problems, the identified problem entities, the determined relationship types and any assigned filtering or certainty values/percentages in order to determine one or more root causes of any identified problems. Thus, the rules-based engine may filter out any identified failures/problems that are simply incidental to the actual failures/problems by determining one or more root causes.

Once one or more root causes have been identified, the rules-based engine may use those root causes along with any other analyses, calculations, and/or assessments regarding the system to formulate alerts, which can be presented to a user. Such alerts may comprise one or more actions the user can take with respect to one or more user-visible entities of the computer system in order to fix any identified problems. Accordingly, rules-based engine 260 may only present alerts regarding actions that the user can take with respect to the file system and/or volume.

What is user-visible may be dependent on an identification of the user. For example, a user that is an information technology (IT) professional or an administrator of the system may have access to more user-visible entities than an ordinary user. In another example, an engineer may have more access to various entities in a system than an administrator. For instance, an engineer may have access to all entities of a system, while an administrator of the same system may have at least partially restricted access.

Similarly, the complexity of actions set forth in an alert may be dependent on an identification of the user. For example, an IT professional or system administrator may receive alerts with complex technical aspects and actions to be taken, while an ordinary user may receive alerts with minimal technical detail and complexity. Likewise, an engineer may receive alerts with even more complex technical aspects and actions to be taken than an administrator. Identification of the user can take place through any appropriate means. For instance, a user may be able to input credentials, input subscription information, request more detailed access to the system, and so forth. Accordingly, a user, such as an engineer or other technical person, may be able to input credentials that allow the user to see entities and problems that would not otherwise be user-visible (i.e., those entities/problems had been filtered out).

As briefly mentioned, an alert may comprise any appropriate action to be taken by a user to restore a system to good health. An alert may further comprise a level of urgency for each action stated. The level of urgency may be based on any applicable factors, including the persistence of a problem, the impact of a problem on the overall system, the impact of the problem on a specific entity (or entities), and so forth. For example, if an identified problem comprises having only one redundant disk, the level of urgency is likely to be very high.

When one or more actions are presented to the user in an alert, those actions may further outline a priority of what actions to be taken by the user are most urgent (i.e., in what order to take actions based on urgency). Potential actions presented in an alert are almost limitless and may include restarting a computer, removing a software program, installing a software program, resetting a computer to factory settings, replacing a hardware storage device, replacing a fan, replacing a sensor, and so forth.

In some embodiments, any determined root causes may be fixed by the computer system itself or an administrator of the system, rather than presenting an alert to the user. In other embodiments, the rules-based engine may filter out some root causes from presentation to the user, thus allowing the computer system or an administrator to fix those particular root causes. For example, the computer system and/or an administrator may fix every root cause possible, thus presenting to the user only the root causes that necessitate an external actor. In yet other embodiments, the rules-based engine may filter out all of the root causes from presentation to the user, whether or not they are fixed by the computer system or an administrator of the system. For example, the rules-based engine may determine that none of the root causes are at an urgency level that necessitates either presenting an alert to a user or having the computer system or an administrator fix the root cause.

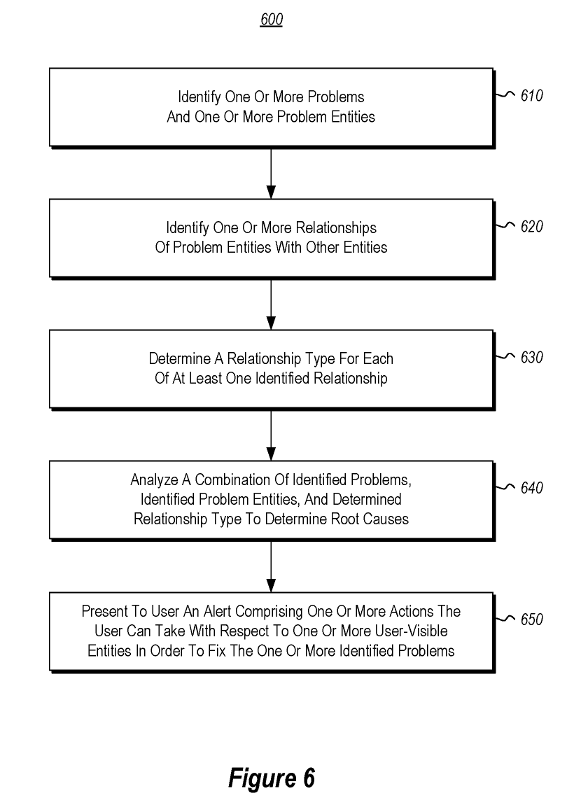

FIG. 6 illustrates a flow chart of an example method 600 for monitoring and maintaining the health of a computer system based on the relationships of entities of the computer system. Method 600 will be described with respect to the components and data of computer architecture 200. Likewise, the method 600 will also be described using an example comprising the failure of physical disk 420A, as well as the failure of pool 410. The method begins when one or more problems within a computer system and one or more entities within the computer system that are causing the one or more problems are identified (Act 610). In this instance, the rules-based engine may have identified problems such as a loss of redundancy and a failure of the disk, seen in pool 410 and physical disk 420A, respectively.

One or more relationships the problem entities have with other entities in the computer system are then identified (Act 620). For example, the rules-based engine may determine that the physical disk has a relationship with the pool and that the pool has a relationship with both the physical disks and the virtual disks. A relationship type for each of at least one of the identified relationships is then determined (Act 630). Here, the rules-based engine may identify that the physical disk and the pool have a composition relationship, wherein the physical disk is the component child and the pool is the parent entity.

A combination of the one or more identified problems, the one or more identified problem entities, and the determined relationship type are then analyzed in order to determine one or more root causes of the one or more identified problems (Act 640). Here, because the relationship type of the two problem entities (i.e., the physical disk and the pool) is a composition relationship, the root cause is almost certainly the child component (i.e., the physical disk). Thus, the rules-based engine is very likely to determine that the root cause is a failure of the physical disk.

Finally, based on the one or more root causes, an alert is presented to a user, wherein the alert comprises one or more actions the user can take with respect to one or more user-visible entities of the computer system in order to fix the one or more identified problems (Act 650). Here, the alert may comprise any of a number of things, however, it is likely that at the very least, the physical disk would need to be replaced. Depending on the identification of the user, replacing the disk may not be presented as an alert to the user. For example, if the user is an administrator of the computer system then that user may receive such an alert. Alternatively, a typical user may not receive such an alert because the physical disk is not likely to be a user-visible entity in that case. Therefore, such a root cause (i.e., one that is not related to a user-visible entity) in the case of a typical user would likely be a problem that would need to be corrected by the system itself or an administrator of the system.

In this way, large, complex computer systems that have cascading, or incidental, problems that obscure the root cause(s) of the problems can utilize the rules-based engine to filter out those incidental problems in order to focus on correcting the actual root cause(s). Furthermore, alerts are provided to users based on an identification of the user, such that the alerts only contain actionable content relating to entities that the user can view and understand.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system for monitoring the health of the computer system based on entity relationships, comprising:
one or more processors; and
one or more storage devices having stored thereon computer-executable instructions that are executable by the one or more processors, and that configure the system to monitor the health of the computer system based on entity relationships, including computer-executable instructions that configure the computer system to perform at least the following:
identify one or more problems within the computer system and one or more entities within the computer system that are causing the one or more problems;
identify one or more relationships that the one or more problem entities have with other entities in the computer system;
determine a relationship type for each of at least one identified relationship;
analyze a combination of the one or more identified problems, the one or more identified problem entities, and the determined relationship type to thereby determine one or more root causes of the one or more problems; and
based on the one or more root causes, present to a user an alert comprising one or more actions the user can take with respect to one or more user-visible entities of the computer system, to thereby fix the one or more identified problems.

2. The computer system of claim 1, wherein a rules-based engine is used to determine the one or more root causes.

3. The computer system of claim 1, wherein the one or more actions presented to the user are based on a priority of what actions are most urgent.

4. The computer system of claim 1, wherein a determination that the one or more user-visible entities are visible is made based on an identification of the user.

5. The computer system of claim 1, wherein at least one of the one or more root causes of the one or more problems is fixed by the computer system rather than presenting an alert to the user.

6. The computer system of claim 1, wherein the determined relationship type comprises an entity contained within a different entity.

7. The computer system of claim 1, wherein one of the one or more identified problems is loss of redundancy.

8. The computer system of claim 1, wherein a filtering value is assigned to each identified problem entity based on one or more determined relationship types associated with each identified problem entity.

9. A method, implemented at a computer system that includes one or more processors, for monitoring the health of the computer system based on entity relationships, the method comprising:
identifying one or more problems within the computer system and one or more entities within the computer system that are causing the one or more problems;
identifying one or more relationships that the one or more problem entities have with other entities in the computer system;
determining a relationship type for each of at least one identified relationship;
analyzing a combination of the one or more identified problems, the one or more identified problem entities, and the determined relationship type to thereby determine one or more root causes of the one or more problems; and
based on the one or more root causes, presenting to a user an alert comprising one or more actions the user can take with respect to one or more user-visible entities of the computer system, to thereby fix the one or more identified problems.

10. The method of claim 9, the method being performed by a rules-based engine that is used to determine the one or more root causes.

11. The method of claim 10, the method further comprising:
the rules-based engine filtering out at least one of the one or more root causes of the one or more problems rather than presenting an alert to the user.

12. The method of claim 9, the one or more actions presented to the user are based on a priority of what actions are most urgent.

13. The method of claim 9, the method further comprising the following prior to the presentation of the alert to the user:
identifying the user; and
based on the identification of the user, determining that the one or more user-visible entities are visible.

14. The method of claim 9, wherein the determined relationship type comprises an entity that is composed of at least one component entity.

15. The method of claim 9, wherein one of the one or more identified problems is a disk failure.

16. A computer system for monitoring the health of the computer system based on entity relationships, comprising:
one or more processors; and
one or more storage devices having stored thereon computer-executable instructions that are executable by the one or more processors to configure the system to monitor the health of the computer system based on entity relationships by instantiating and/or operating the following:
a rules-based engine that analyzes the health of each entity of the computer system, as well as the overall health of the entire system, including at least the following:
identify one or more problems within the computer system and one or more entities within the computer system that are causing the one or more problems;
identify one or more relationships that the one or more problem entities have with other entities in the computer system;
determine a relationship type for each of at least one identified relationship;
analyze a combination of the one or more identified problems, the one or more identified problem entities, and the determined relationship type to thereby determine one or more root causes of the one or more problems; and
based on the one or more root causes, present to a user an alert comprising one or more actions the user can take with respect to one or more user-visible entities of the computer system, to thereby fix the one or more identified problems.

17. The computer system of claim 16, wherein the one or more actions presented to the user are based on a priority of what actions are most urgent.

18. The computer system of claim 16, wherein a determination as to what entities are user-visible entities is made based on an identification of the user.

19. The computer system of claim 16, wherein at least one of the one or more root causes of the one or more problems is fixed by the computer system rather than presenting an alert to the user.

20. The computer system of claim 16, wherein the determined relationship type comprises an entity that is loosely related to one or more different entities.
